(19) United States
(12) Patent Application Publication
(10) Pub. No.: US 2006/0146690 A1
(43) Pub. Date: Jul. 6, 2006

(54) Methods, circuits and computer program products for estimating frequency domain channel in a DVB-T receiver using transform domain complex filtering

(76) Inventors: Junling Zhang, Gyeonggi-do (KR); Kyu-man Lee, Seoul (KR); Masaki Sato, Gyeonggi-do (KR)

Correspondence Address: MYERS BIGEL SIBLEY & SAJOVEC, PO BOX 37428, RALEIGH, NC, 27627, US

(21) Appl. No.: 11/206,932

(22) Filed: Aug. 18, 2005

(30) Foreign Application Priority Data
Aug. 19, 2004 (KR) 10-2004-0065381

(51) Int. Cl. H04J 11/00

(52) U.S. Cl. 370/203

(57) ABSTRACT

A method for performing channel estimation in a receiver of a digital terrestrial television system can be provided by interpolating a complex signal in a frequency domain using a complex filter. The interpolation can be provided, for example, by interpolating, in the time domain, a fast fourier transformed orthogonal frequency division multiplexing (OFDM) signal and interpolating, in a frequency domain, a complex OFDM signal using the complex filter with a predetermined bandwidth. Related equalizers and computer program products are also disclosed.

### CROSS-REFERENCE TO RELATED APPLICATION

This application claims priority to Korean Patent Application No. 10-2004-0065381, filed in the Korean Intellectual Patent Office on Aug. 19, 2004, the entire disclosure of which is incorporated herein by reference.

### FIELD OF THE INVENTION

The present invention relates to receivers, and more particularly, to the channel estimation for digital television.

### BACKGROUND

Methods of transmitting digital TV can be divided into a vestigial side band (VSB) method, which is a single carrier modulation method, and a coded orthogonal frequency divisional multiplexing (COFDM) method, which is a multiple carrier modulation method. A digital video broadcasting-terrestrial (DVB-T) system using the COFDM method has been adopted by European countries as a next-generation digital terrestrial TV transmission system. Many European countries are conducting test-broadcasts using the DVB-T system, and the DVB-T system shares the global digital market with the U.S. standard. Additional information regarding DVB can be found on the Internet at dvb.org.

A DVB-T modulation/demodulation method adopts OFDM in consideration that the digital TV transmission system is terrestrial. Unlike a general single carrier modulation/demodulation method in which information is sent consecutively for a predetermined period of time, the OFDM method can allow information to be dispersed and sent over a plurality of frequencies. Therefore, the OFDM method may be profitable for a multi-path channel.

FIG. 1 is a block diagram of a conventional DVB-T receiver. Referring to FIG. 1, the DVB-T receiver includes an analog-to-digital converter (ADC) 1, a demodulator 2, a coarse symbol timing recovery (STR) & carrier recovery (CR) unit 3, a fast fourier transform (FFT) unit 4, a fine CR unit 5, an adder 6, a number controlled oscillator (NCO) 7, a fine STR unit 8, an equalizer 9, and a forward error correction (FEC) unit 10.

The ADC 1 receives an analog signal r(t) and samples the analog signal r(t) with a fixed sampling frequency. The demodulator 2 controlled by the fine STR 8 and the NCO 7 receives samples generated by the ADC 1 and generates a complex signal r(n) sampled at a baseband in n^{th} time with a sampling frequency of fₛ=1/Tₛ. Tₛ=T_{U}/N_{FFT}, where T_{U} indicates useful duration of an OFDM symbol, and N_{FFT} indicates the size of a fast fourier transform (FFT).

The coarse STR & CR unit 3, which receives the complex signal r(n), removes a guard interval (GI) of the complex signal r(n), generates a starting position of a FFT, and transmits the starting position of the FFT to the FFT unit 4. The FFT unit 4 generates a frequency domain complex signal Rₖ(m) at an m^{th} sub-carrier of a k^{th} OFDM symbol.

The fine CR unit 5, which receives the frequency domain complex signal Rₖ(m), generates a fine carrier frequency offset signal and transmits the fine carrier frequency offset signal to the adder 6. The adder 6 adds a coarse carrier frequency offset signal output from the coarse STR & CR unit 3 to the fine carrier frequency offset signal output from the fine CR 5, and transmits the added carrier frequency offset signal to the NCO 7.

The NCO 7, which receives the added carrier frequency offset signal, generates a carrier and transmits the carrier to the demodulator 2. The fine STR unit 8, which receives the frequency domain complex signal Rₖ(m), removes the GI in the complex signal r(n), generates an FFT starting position offset signal, and transmits the FFT starting position offset signal to the FFT unit 4. The fine STR 8 also generates a sampling frequency offset signal and transmits the sampling frequency offset signal to the demodulator 2.

The equalizer 9 receives the frequency domain complex signal Rₖ(m) and compensates for distortion of an FFT OFDM signal that occurs over a transmission channel, by estimating transmission channel characteristics of an OFDM signal using scattered pilots (SPs).

The FEC 10 receives a signal compensated by the equalizer 9 and Viterbi-decodes the signal.

An operation of the DVB-T receiver will now be described with reference to FIG. 1. An analog signal r(t) is received and sampled by the ADC 1 with a fixed sampling frequency. Signals sampled by the ADC 1 are processed by the demodulator 2, which generates a complex signal r(n) sampled at a baseband in the n^{th} time with the sampling frequency of fₛ=1/Tₛ.

Then, the complex signal r(n) is input to the coarse STR & CR unit 3 and the FFT unit 4. In a signal path, the complex signal r(n) is processed by the coarse STR & CR unit 3. The coarse STR & CR unit 3 removes the GI of the complex signal r(n), generates a coarse FFT starting position offset signal, and transmits the coarse FFT starting position offset signal to the FFT unit 4. In addition, the coarse STR & CR unit 3 generates coarse carrier frequency offset information and transmits the coarse carrier frequency offset information to the adder 6.

In another signal path, the complex signal r(n) is processed by the FFT unit 4. The FFT unit 4 generates the frequency domain complex signal Rₖ(m) at the m^{th} subcarrier of the k^{th} OFDM symbol. The FFT starting position offset signal input to the FFT unit 4 is controlled by the coarse STR & CR unit 3 and the fine STR unit 8.

The frequency domain complex signal Rₖ(m) is input to the fine CR unit 5, the fine STR unit 8, and the equalizer 9. In a signal path, the frequency domain complex signal Rₖ(m) is processed by the fine CR unit 5. The fine CR unit 5 generates a carrier frequency offset signal and transmits the carrier frequency offset signal to the adder 6. The adder 6 adds the carrier frequency offset signal to the coarse carrier frequency offset signal generated by the coarse STR & CR unit 3. Then, the added carrier frequency offset signal is input to the NCO 7. The NCO 7 generates a carrier and transmits the carrier to the demodulator 2.

In another signal path, the frequency domain complex signal Rₖ(m) is processed by the fine STR unit 8. The fine STR 8 removes the GI of the complex signal r(n), generates an FFT starting position offset signal, and transmits the FFT starting position offset signal to the FFT unit 4. In addition, the fine STR 8 generates a sampling frequency offset signal and transmits the sampling frequency offset signal to the demodulator 2. The demodulator 2 compensates for sampling frequency offset caused by the ADC 1. In yet another signal path, the frequency domain complex signal Rₖ(m) is input to the equalizer 9. The equalizer 9 completes channel estimation and compensation. A signal compensated by the equalizer 9 is input to and Viterbi-decoded by the FEC 10.

FIG. 2 is a block diagram of the equalizer 9 of the DVB-T receiver of FIG. 1. Referring to FIG. 2, the equalizer 9 includes a time domain interpolator 901, a frequency domain interpolator 902, and a compensator 903. After symbol timing recovery (STR) and carrier recovery (CR), the equalizer 9 performs channel estimation and compensation. A method of applying the scattered pilots (SPs) is defined by a DVB-T standard and requires channel estimation through interpolation. In other words, after a plurality of channel impulse response (CIR) samples using the SPs are obtained, they are interpolated in a time domain and then in a frequency domain for channel estimation.

Referring to FIG. 2 and the DVB-T standard, the SPs in the complex signal Rₖ(m), m⇄[Kₘᵢₙ, Kₘₐₓ]} (where Kₘᵢₙ and Kₘₐₓ indicate minimum and maximum subcarrier indices of an OFDM symbol, respectively) over several OFDM symbols are first interpolated in the time domain to generate sampled CIR estimation in the frequency domain.

Then, the CIR estimation samples are interpolated in the frequency domain using a real low pass filter (LPF) in a transform domain with a predetermined bandwidth. Consequently, reliable results of channel estimation may be achieved.

FIG. 3 is a block diagram of the frequency domain interpolator 902 illustrated in FIG. 2. Referring to FIG. 3, CIR samples processed by the time domain interpolator 901 included in the equalizer 9 are divided into an in-phase (real) and a quadrature (imaginary) signal. The real signal is filtered by a real LPF unit 904, and the imaginary signal is filtered by an imaginary LPF unit 905. The adder 906 adds the filtered real signal to the imaginary signal to generate a complex signal and output the result.

Since functions of the real LPF unit 904 and imaginary unit LPF unit 905 can be considered analogous to one another, a frequency domain interpolation method using only the real LPF unit 904 will be now described.

FIG. 4 is a graph illustrating signals processed by the frequency domain interpolator 902 of FIG. 3. Based on the DVB-T standard, CIR estimation samples in the frequency domain for every three subcarriers may be obtained after time domain interpolation by the time domain interpolator 901 of FIG. 2. The CIR estimation samples in the frequency domain are illustrated in the upper left part of FIG. 4. A real CIR estimation in the transform domain after the time domain interpolation based on an interpolation theorem is also illustrated in the upper right part of FIG. 4.

The real CIR estimation in the transform domain after the time domain interpolation is multiplied by a real LPF in the transform domain illustrated in the lower right part of FIG. 4. Then, the CIR estimation in the frequency domain is generated at every subcarrier, which is illustrated in the lower left part of FIG. 4. The above operation is defined as

$$\begin{matrix}real \{ {CIR}_{k , est} ( m ) \} = {\sum }_{i = - L}^{L} real \{ {\hat{R}}_{k} ( m + i \vert ( m + i ) ∈ {P}_{SP} ) \} \cdot {w}_{real} ( i ) & ( 1 ) \\ imag \{ {CIR}_{k , est} ( m ) \} = {\sum }_{i = - L}^{L} imag \{ {\hat{R}}_{k} ( m + i \vert ( m + i ) ∈ {P}_{SP} ) \} \cdot {w}_{real} ( i ) , & ( 2 )\end{matrix}$$

where Equation 1 indicates an operation of the real LPF unit 904, and Equation 2 indicates an operation of the imaginary LPF unit 905. In addition, real {·} and imag {·} denote real and imaginary components of a complex signal, respectively. CIR_{k,est}(m) indicates a CIR estimated after the frequency domain interpolation at the m^{th} subcarrier of the k^{th} OFDM symbol, and \hat{R}ₖ (j|εP_{SP}) indicates a CIR estimated after the time domain interpolation at the j^{th} subcarrier of the k^{th} OFDM symbol. P_{SP} indicates a set of subcarrier indices having CIR estimations already generated after the time domain interpolation, and wᵣₑₐₗ(i), iΕ[−L, L] indicates real coefficients in the frequency domain of a real LPF in the transform domain in the lower right part of FIG. 4. 2·L+1 denotes an order of the real LPF.

After the frequency domain interpolation by the frequency domain interpolator 902 of FIG. 2, CIR estimations for every subcarrier are obtained and input to the compensator 903 of FIG. 2, which completes CIR compensation.

Referring to the right part of FIG. 4, a maximum unaliased bandwidth of the real CIR estimation after the time domain interpolation in the transform domain, that is, the maximum delay time of an echo in a multi-path channel that the real LPF in the transform domain can deal with, is based on a Nyquist sampling theorem, (T_{U}/3)/2=T_{U}/6, which is smaller than requirements of a NorDig specification.

A desired signal includes a direct path and an echo. The echo has the same power (0 dB) as a direct path signal, is delayed by 1.95 μs through 0.95 times a length of the guide interval (GI), and has a zero-degree phase at a channel center. Here, the size of a FFT is 8 K, and the length of the GI is ¼ and ⅛ of an OFDM symbol.

FIG. 5 is a graph illustrating channel compensation errors that may occur when the equalizer 9 is used. As described above, when the equalizer 9 performs real low-pass filtering, the maximum delay time of an echo in the multi-path channel may be limited to T_{U}/6. If the delay time of the echo exceeds T_{U}/6 as illustrated in FIG. 5(a), errors may occur in channel estimation and compensation.

If the delay time of the echo exceeds the maximum delay time, the real LPF may widen its bandwidth as illustrated in FIG. 5(b) and set interpolation in the frequency domain. In this case, however, neighboring real CIR estimations may overlap in the same transform domain. Therefore, although the real LPF is used, the neighboring real CIR estimations may still remain as indicated in a deviant line in FIG. 5(c), thereby causing errors in the channel estimation.

Further, if the bandwidth of the real LPF is limited to or narrower than T_{U}/6, the real CIR illustrated in FIG. 5(a) may not be completely filtered, thereby causing errors in the channel estimation.

### SUMMARY

Embodiments according to the invention can provide methods, circuits and computer program products for estimating frequency domain channel in a DVB-T receiver using transform domain complex filtering. Pursuant to these embodiments, a method for performing channel estimation in a receiver of a digital terrestrial television system can be provided by interpolating a complex signal in a frequency domain using a complex filter. In some embodiments according to the invention, interpolating includes interpolating the complex signal in the frequency domain using only a complex filter.

In some embodiments according to the invention, interpolating further includes interpolating an orthogonal frequency division multiplexing (OFDM) signal in a time domain to provide the complex signal. In some embodiments according to the invention, interpolating the OFDM signal in the time domain precedes interpolating the complex signal using the complex filter. In some embodiments according to the invention, the complex signal includes an in-phase (I) signal component and a quadrature (Q) phase component. In some embodiments according to the invention, the I signal component and the Q phase component are filtered together using the complex filter.

In some embodiments according to the invention, interpolating a complex signal in a frequency domain using a complex filter further includes interpolating, in the time domain, a fast fourier transformed orthogonal frequency division multiplexing (OFDM) signal and interpolating, in a frequency domain, a complex OFDM signal using the complex filter with a predetermined bandwidth.

In some embodiments according to the invention, the method further includes compensating for distortion over a transmission channel carrying the OFDM signal after interpolating the OFDM signal in the time domain and after interpolating the complex signal in the frequency domain. In some embodiments according to the invention, interpolating, in a frequency domain, includes multiplying the complex OFDM signal in a transform domain after the time domain interpolation by the complex filter in the transform domain.

In some embodiments according to the invention, multiplying is provided by:

$${CIR}_{k , est} ( m ) = {\sum }_{i = - L}^{L} {\hat{R}}_{k} ( m + i \vert ( m + i ) ∈ {P}_{SP} ) \} \cdot {w}_{cmplx}^{*} ( i ) ,$$

where CIR_{k,est}(m) indicates a channel impulse response (CIR) estimated after the frequency domain interpolation at an m-th subcarrier of a k-th OFDM symbol, \hat{R}ₖ (j|jεP_{SP}) indicates a CIR estimated after the time domain interpolation at a j-th subcarrier of the k-th OFDM symbol, P_{SP} indicates a set of subcarrier indices having the CIR estimation already generated by the time domain interpolation, w_{cmplx}(i), iΕ[−L, L] indicates complex coefficients in the frequency domain of the complex filter in the transform domain, 2·L+1 denotes an order of the complex filter, and (·)* denotes a conjugate signal of the complex signal.

In some embodiments according to the invention, a bandwidth of the complex filter is a duration of a guide interval. In some embodiments according to the invention, a starting frequency of the complex filter in the transform domain is more than 2.5 percent smaller than the duration of the guide interval. In some embodiments according to the invention, a cut-off frequency of the complex filter in the transform domain is less than 97.5 percent of the duration of the guide interval. In some embodiments according to the invention, the digital terrestrial television system is a digital video broadcasting-terrestrial system.

In some embodiments according to the invention, an equalizer for estimating and compensating for a channel in a digital terrestrial television receiver includes a complex filter configured to interpolate a complex signal in a frequency domain. In some embodiments according to the invention, only a complex filter is used to interpolate the complex signal in the frequency domain.

In some embodiments according to the invention, a time domain interpolator is configured to receive a fast fourier transformed OFDM signal and to interpolate the fast fourier transformed OFDM signal in a time domain. A frequency domain interpolator is configured to interpolate a complex OFDM signal interpolated in the time domain using a complex filter with a predetermined bandwidth. A compensator is configured to compensate for distortion that occurs over a transmission channel in response to an OFDM signal after time domain interpolation and an OFDM signal after frequency domain interpolation.

In some embodiments according to the invention, a European digital video broadcasting-terrestrial (DVB-T) receiver includes an equalizer with a time domain interpolator configured to receive a fast fourier transformed OFDM signal and to interpolate the fast fourier transformed OFDM signal in a time domain. A frequency domain interpolator is configured to interpolate a complex OFDM signal interpolated in the time domain using a complex filter with a predetermined bandwidth. A compensator is configured to compensate for distortion that occurs over a transmission channel in response to an OFDM signal after time domain interpolation and an OFDM signal after frequency domain interpolation.

### BRIEF DESCRIPTION OF THE DRAWINGS

FIG. 1 is a block diagram of a conventional digital video broadcasting-terrestrial (DVB-T) receiver;

FIG. 2 is a block diagram of a conventional equalizer of the DVB-T receiver of FIG. 1;

FIG. 3 is a block diagram of a frequency domain interpolator illustrated in FIG. 2;

FIG. 4 is a graph illustrating signals processed by the frequency domain interpolator of FIG. 3;

FIG. 5 is a graph illustrating channel compensation errors that occur when the equalizer of FIG. 2 is used;

FIG. 6 is a graph comparing a real signal with a complex signal;

FIG. 7 is a graph comparing a real filter with a complex filter;

FIG. 8 is a block diagram of a frequency domain interpolator in some embodiments according to the present invention; and

FIG. 9 is a graph illustrating signal processing by an equalizer of FIG. 8 in some embodiments according to the present invention.

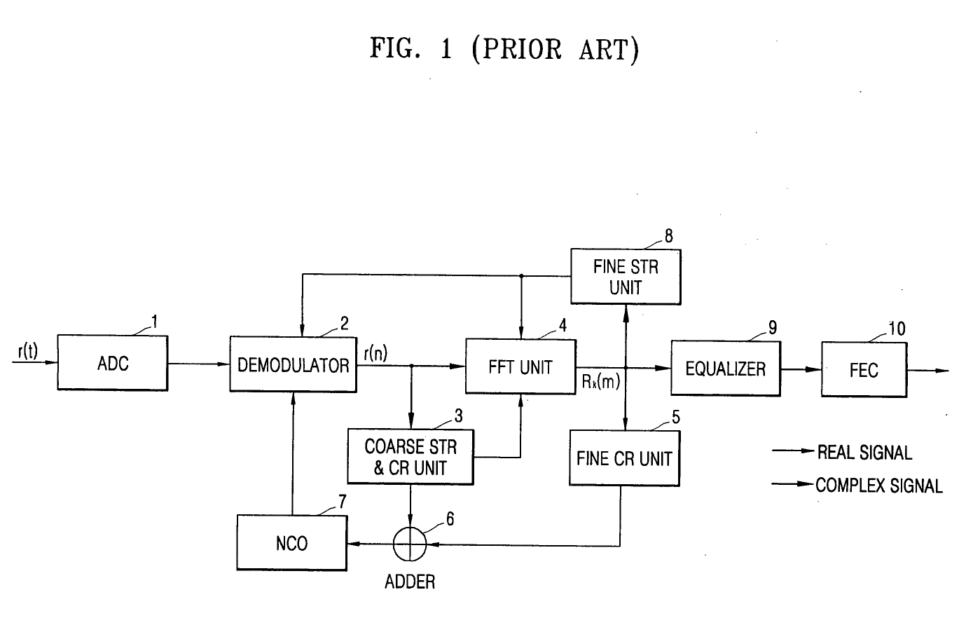

### DETAILED DESCRIPTION OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, receivers, equalizers, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to block diagram illustrations of methods, equalizers, receivers, systems, and computer program products in accordance with exemplary embodiments of the invention. It will be understood that each block of the diagram illustrations, and combinations of blocks, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

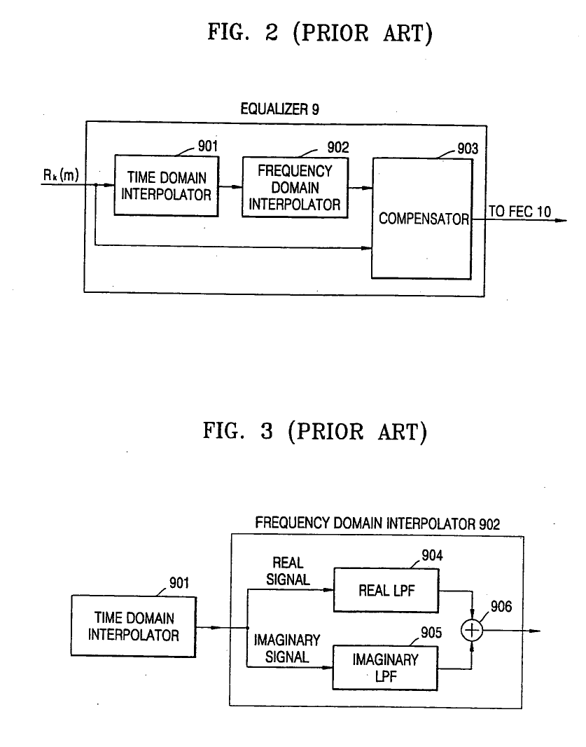

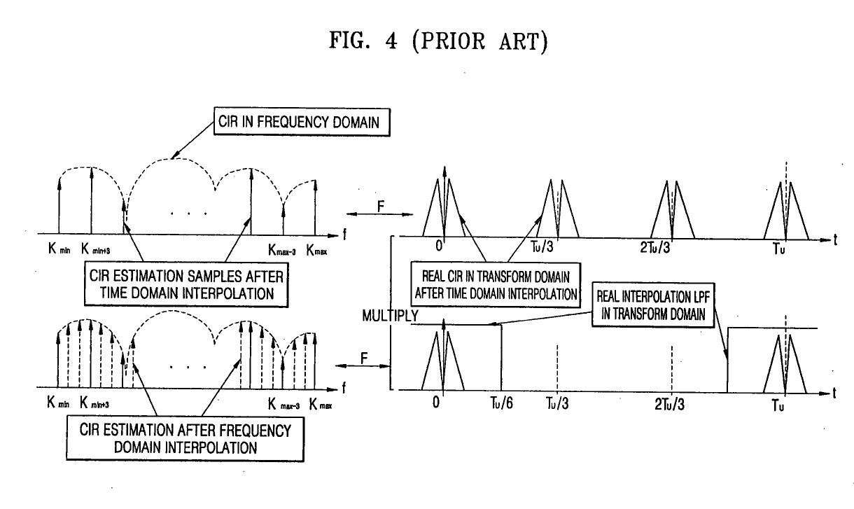

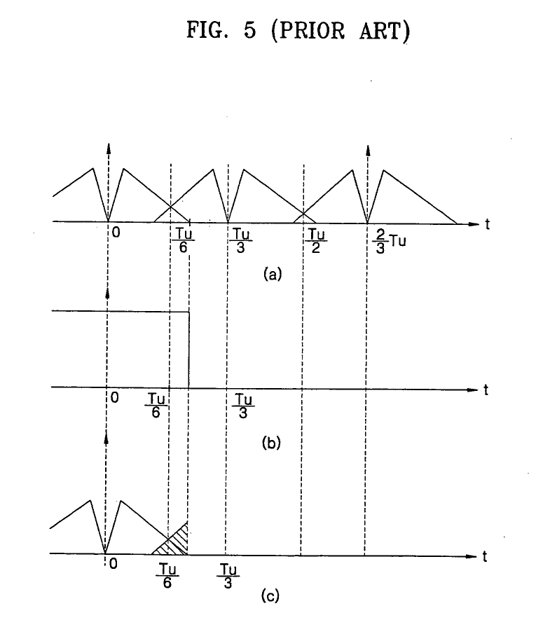

Referring to FIG. 2, a complex signal Rₖ(m) output from the time domain interpolator 901 included in the equalizer 9 is a signal obtained by adding an in-phase component signal (I signal) to a quadrature component signal (Q signal). Therefore, the conventional frequency domain interpolator 902 extracts a real signal from the complex signal Rₖ(m) using the I and Q signals and interpolates the real signal in a frequency domain using a real low pass filter (LPF).

As appreciated by the present inventors, after the time domain interpolation, if the CIR estimation in the transform domain exists outside a profile of the real LPF for the frequency domain interpolation, the performance of the DVB-T receiver may be seriously undermined by the distortion of the CIR estimation after the frequency domain interpolation. Therefore, some embodiments according to the invention allow an increase in the maximum delay time of the echo in the multi-path channel of more than T_{U}/6.

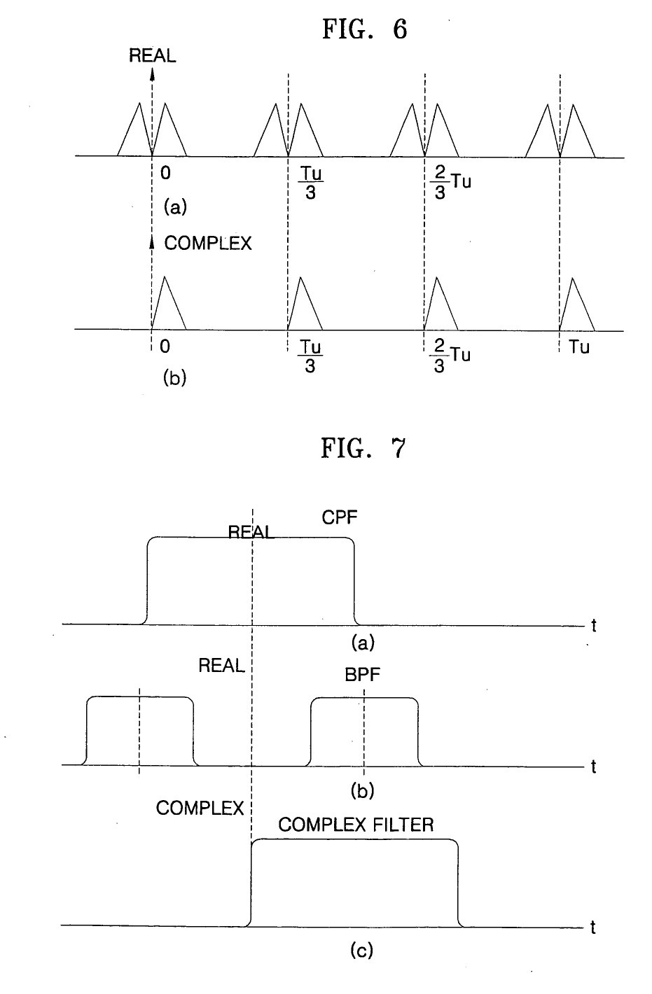

FIG. 6 is a graph comparing a real signal with a complex signal. Referring to FIG. 6, the real signal illustrated in FIG. 6(a) is symmetric whereas the complex signal illustrated in FIG. 6(b) is asymmetric. Therefore, if a delay time of an echo channel exceeds (T_{U}/3)2=T_{U}/6, the real signal overlaps its neighbouring signals. On the other hand, if the delay time of the echo channel exceeds T_{U}/6, the complex signal does not overlap its neighbouring signals.

As appreciated by the present inventors, by taking advantage of asymmetric characteristics of the complex signal, some embodiments according to the invention may allow an increase in delay time by interpolating the complex signal, rather than the real signal, in the frequency domain using a complex filter.

FIG. 7 is a graph comparing a real filter with a complex filter. FIGS. 7(a) and 7(b) indicate real filters. Specifically, FIG. 7(a) indicates a real LPF, and FIG. 7(b) indicates a real band pass filter (BPF). Referring to FIGS. 7(a) through 7(c), the real filters, which are symmetric, do filtering symmetrically about a central axis in a transform domain, while the complex filter selects and filters a particular region.

Therefore, equalizers of the DVB-T receiver in some embodiments according to the invention, may process the complex signal at a time instead of dividing the complex signal into a real signal and an imaginary signal and then processing the complex signal as separate components. Moreover, the delay time of the echo channel may be doubled compared with when the real signal is used.

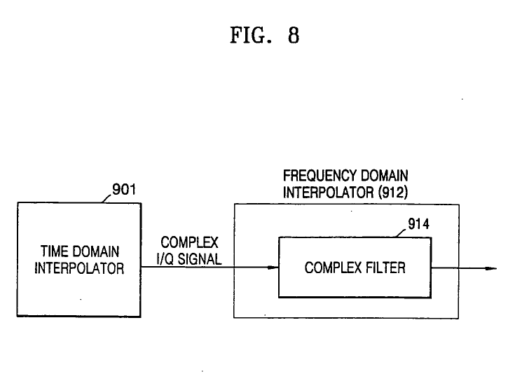

FIG. 8 is a block diagram of a frequency domain interpolator 912 according to the present invention. Referring to FIG. 8, the frequency domain interpolator 912 receives a complex channel impulse response (CIR) estimation sample output from a time domain interpolator 901 and filters the complex CIR estimation sample using a complex filter unit 914.

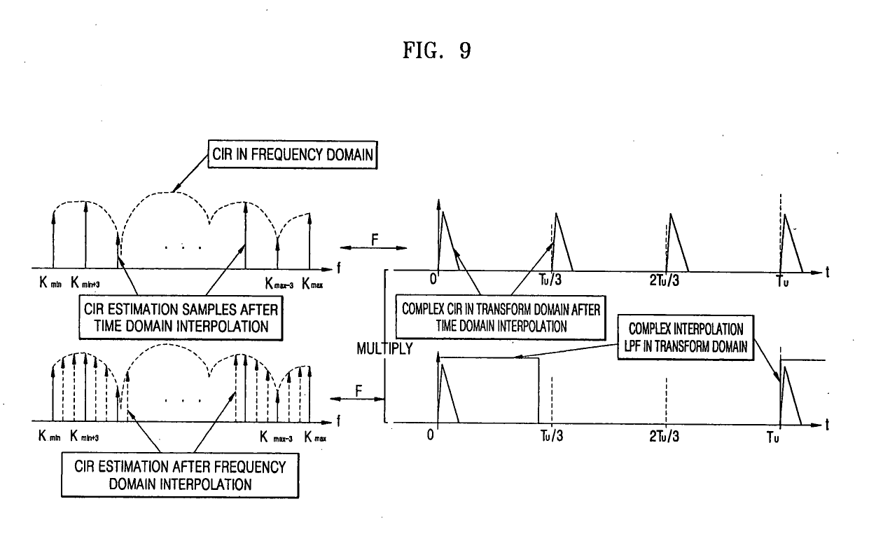

FIG. 9 is a graph illustrating signal processing by an equalizer of FIG. 8 according to the present invention. A CIR estimation in the frequency domain illustrated in the upper left part of FIG. 9 is a CIR estimation sample in the frequency domain that was processed by the time domain interpolator 901 of the equalizer 9 of FIG. 2. The upper right part of FIG. 9 illustrates the CIR estimation sample in the upper left part of FIG. 9 in the transform domain.

Referring to the upper right part of FIG. 9, since only the delay time exists in a multi-path channel, a left part of the complex CIR estimation in the transform domain after the time domain interpolation does not exist.

The lower right part of FIG. 9 illustrates a complex filter in the transform domain and a result of multiplying the complex filter by the complex CIR estimation in the transform domain after the time domain interpolation illustrated in the upper right of FIG. 9. As described above, since the complex CIR and the complex filter are asymmetric in the transform domain, they may have bandwidths a half as wide as the symmetric real CIR and the real filter. In other words, a maximum unaliased bandwidth of the complex CIR estimation in the transform domain after the time domain interpolation, that is, maximum delay time of an echo in a multipath channel that the complex filter in the transform domain can process, is T_{U}/3, which is larger than the requirements of a NorDig specification. Additional information regarding the NorDig specification can be found on the Internet at nordig.org.

The lower left part of FIG. 9 illustrates the result of filtering illustrated in the lower right of FIG. 9 in the frequency domain. In other words, the lower left part of FIG. 9 illustrates the CIR estimation in the frequency domain after the CIR estimation has been processed by the frequency domain interpolator 912.

Referring to the lower left of FIG. 9, if a complex CIR sample is complex-filtered for the frequency domain interpolation, CIR estimations may be generated at all subcarriers.

Inverse frequency domain interpolation in the transform domain using the complex filter 914 in the transform domain according to the present invention is defined as

$${CIR}_{k , est} ( m ) = {\sum }_{i = - L}^{L} {\hat{R}}_{k} ( m + i \vert ( m + i ) ∈ {P}_{SP} ) \} \cdot {w}_{cmplx}^{*} ( i ) , \qquad ( 3 )$$

where CIR_{k,est}(m) indicates a CIR estimated after the frequency domain interpolation at an m^{th} subcarrier of a k^{th} OFDM symbol, and \hat{R}ₖ (j|jεP_{SP}) indicates a CIR estimated after the time domain interpolation at a j^{th} subcarrier of the k^{th} OFDM symbol. P_{SP} indicates a set of subcarrier indices having the CIR estimation already generated by the time domain interpolation, and w_{cmplx}(i), iΕ[−L, L] indicates complex coefficients in the frequency domain of the complex filter in the transform domain in the lower right part of FIG. 9. 2·L+1 denotes an order of the complex filter, and (·)* denotes a conjugate signal of the complex signal.

Unlike the conventional frequency domain interpolator 902 of the equalizer 9, which uses a set of real coefficients, the frequency domain interpolator 912 in equalizers according to some embodiments of the present invention completes complex interpolation in the frequency domain using a set of complex coefficients.

When the equalizer according to the present invention is used, as illustrated in the lower right part of FIG. 9, the maximum bandwidth of the complex filter in the transform domain for the frequency domain interpolation may be widened to T_{U}/3 in theory.

If the maximum bandwidth of the complex filter is widened to T_{U}/3, the maximum delay time of the echo channel may also be increased to T_{U}/3. In addition, even in a poor receiving environment, such as the 0 dB echo channel, channel estimation and compensation may be conducted properly.

In other words, since the CIR estimation in the transform domain after the time domain interpolation can exist within the profile of the complex filter for the frequency domain interpolation, the distortion of the CIR estimation after the frequency domain interpolation may be prevented or reduced.

Meanwhile, as the bandwidth of the complex filter becomes larger, the complex filter includes larger noise power, which may deteriorate the performance of the CIR estimation after the frequency domain interpolation. In addition, an FFT starting position error (STR error) affects a starting position of the CIR estimation in the transform domain after the time domain interpolation. The CIR estimation in the transform domain after the time domain interpolation may exist outside the profile of the complex filter for the frequency domain interpolation, which should also be considered for effective equalizing process.

In summary, parameters of the complex filter may be set in consideration of requirements of the NorDig specification, noise contained in the complex filter for the frequency domain interpolation, and STR errors. The parameters of the complex filter in the transform domain for the frequency domain interpolation according to some embodiments of the present invention may be defined as follows.

The bandwidth of the complex filter in the transform domain is the duration of the guide interval. Second, a “starting frequency” of the complex filter in the transform domain is more than 2.5% smaller than the duration of the guide interval. Third, a “cut-off frequency” of the complex filter in the transform domain is less than 97.5% of the duration of the guide interval.

By setting the parameters in this way, the CIR estimation in the transform domain for the noise contained in the complex filter and the STR errors can exist in the profile of the complex filter for the frequency domain interpolation.

An equalizer of a DVB-T receiver according to the present invention may more than double a maximum delay time of an echo channel that satisfies a Nyquist theorem. Therefore, since a CIR estimation can exist within a profile of a complex filter for frequency domain interpolation, distortion of the CIR estimation after the frequency domain interpolation can be prevented.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed:

1. A method for performing channel estimation in a receiver of a digital terrestrial television system comprising interpolating a complex signal in a frequency domain using a complex filter.

2. A method according to claim 1 wherein interpolating comprises interpolating the complex signal in the frequency domain using only a complex filter.

3. A method according to claim 2 wherein the interpolating further comprises:
interpolating an orthogonal frequency division multiplexing (OFDM) signal in a time domain to provide the complex signal.

4. A method according to claim 3 wherein interpolating the OFDM signal in the time domain precedes interpolating the complex signal using the complex filter.

5. A method according to claim 1 wherein the complex signal comprises an in-phase (I) signal component and a quadrature (Q) phase component.

6. A method according to claim 5 wherein the I signal component and the Q phase component are filtered together using the complex filter.

7. A method according to claim 1 wherein interpolating a complex signal in a frequency domain using a complex filter further comprises:
interpolating, in the time domain, a fast fourier transformed orthogonal frequency division multiplexing (OFDM) signal; and
interpolating, in a frequency domain, a complex OFDM signal using the complex filter with a predetermined bandwidth.

8. A method according to claim 3 further comprising:
compensating for distortion over a transmission channel carrying the OFDM signal after interpolating the OFDM signal in the time domain and after interpolating the complex signal in the frequency domain.

9. A method according to claim 7 wherein interpolating, in a frequency domain, comprises multiplying the complex OFDM signal in a transform domain after the time domain interpolation by the complex filter in the transform domain.

10. A method according to claim 3 wherein the multiplying comprises:
$${CIR}_{k , est} ( m ) = {\sum }_{i = - L}^{L} {\hat{R}}_{k} ( m + i \vert ( m + i ) ∈ {P}_{SP} ) \} \cdot {w}_{cmplx}^{*} ( i ) ,$$
where CIR_{k,est}(m) indicates a channel impulse response (CIR) estimated after the frequency domain interpolation at an m-th subcarrier of a k-th OFDM symbol, \hat{R}ₖ (j|jεP_{SP}) indicates a CIR estimated after the time domain interpolation at a j-th subcarrier of the k-th OFDM symbol, P_{SP} indicates a set of subcarrier indices having the CIR estimation already generated by the time domain interpolation, w_{cmplx}(i), iΕ[−L, L] indicates complex coefficients in the frequency domain of the complex filter in the transform domain, 2·L+1 denotes an order of the complex filter, and (·)* denotes a conjugate signal of the complex signal.

11. A method according to claim 10 wherein a bandwidth of the complex filter is comprises a duration of a guide interval.

12. A method according to claim 11 wherein a starting frequency of the complex filter in the transform domain comprises more than 2.5 percent smaller than the duration of the guide interval.

13. A method according to claim 11 wherein a cut-off frequency of the complex filter in the transform domain comprises less than 97.5 percent of the duration of the guide interval.

14. A method according to claim 1 wherein the digital terrestrial television system comprises a digital video broadcasting-terrestrial system.

15. An equalizer for estimating and compensating for a channel in a digital terrestrial television receiver, the equalizer comprising a complex filter configured to interpolate a complex signal in a frequency domain.

16. A method according to claim 9 wherein only a complex filter is used to interpolate the complex signal in the frequency domain.

17. A computer program product configured to carry out the method according to claim 1.

18. An equalizer estimating and compensating for a channel in a digital terrestrial television receiver, the equalizer comprising:
a time domain interpolator configured to receive a fast fourier transformed OFDM signal and to interpolate the fast fourier transformed OFDM signal in a time domain;
a frequency domain interpolator configured to interpolate a complex OFDM signal interpolated in the time domain using a complex filter with a predetermined bandwidth; and
a compensator configured to compensate for distortion that occurs over a transmission channel in response to an OFDM signal after time domain interpolation and an OFDM signal after frequency domain interpolation.

19. The equalizer of claim 18, wherein the frequency domain interpolator comprises a complex filter unit multiplying the complex OFDM signal in a transform domain after the time domain interpolation by the complex filter in the transform domain.

20. The equalizer of claim 19, wherein the complex filter unit performs the frequency domain interpolation according to the equation
$${CIR}_{k , est} ( m ) = {\sum }_{i = - L}^{L} {\hat{R}}_{k} ( m + i \vert ( m + i ) ∈ {P}_{SP} ) \} \cdot {w}_{cmplx}^{*} ( i ) ,$$
where CIR_{k,est}(m) indicates a channel impulse response (CIR) estimated after the frequency domain interpolation at an m-th subcarrier of a k-th OFDM symbol, \hat{R}ₖ (j|jεP_{SP}) indicates a CIR estimated after the time domain interpolation at a j-th subcarrier of the k-th OFDM symbol, P_{SP} indicates a set of subcarrier indices having the CIR estimation already generated by the time domain interpolation, W_{cmplx}(i), iΕ[−L, L] indicates complex coefficients in the frequency domain of the complex filter in the transform domain, 2·L+1 denotes an order of the complex filter, and (·)* denotes a conjugate signal of the complex signal.

21. The equalizer of claim 20, wherein a bandwidth of the complex filter is a duration of a guide interval.

22. The equalizer of claim 20, wherein a starting frequency of the complex filter in the transform domain is more than 2.5 percent smaller than the duration of the guide interval.

23. The equalizer of claim 20, wherein a cut-off frequency of the complex filter in the transform domain is less than 97.5 percent of the duration of the guide interval.

24. The equalizer of claim 18, wherein the type of digital terrestrial television broadcasting is digital video broadcasting-terrestrial.

25. A European digital video broadcasting-terrestrial (DVB-T) receiver comprising an equalizer, the equalizer comprising:
a time domain interpolator configured to receive a fast fourier transformed OFDM signal and to interpolate the fast fourier transformed OFDM signal in a time domain;
a frequency domain interpolator configured to interpolate a complex OFDM signal interpolated in the time domain using a complex filter with a predetermined bandwidth; and
a compensator configured to compensate for distortion that occurs over a transmission channel in response to an OFDM signal after time domain interpolation and an OFDM signal after frequency domain interpolation.

26. The DVB-T receiver of claim 25, wherein the frequency domain interpolator performs frequency domain interpolation according to the equation
$${CIR}_{k , est} ( m ) = {\sum }_{i = - L}^{L} {\hat{R}}_{k} ( m + i \vert ( m + i ) ∈ {P}_{SP} ) \} \cdot {w}_{cmplx}^{*} ( i ) ,$$
where CIR_{k,est}(m) indicates a channel impulse response (CIR) estimated after the frequency domain interpolation at an m-th subcarrier of a k-th OFDM symbol, \hat{R}ₖ (j|jεP_{SP}) indicates a CIR estimated after the time domain interpolation at a j-th subcarrier of the k-th OFDM symbol, P_{SP} indicates a set of subcarrier indices having the CIR estimation already generated by the time domain interpolation, W_{cmplx}(i), iΕ[−L, L] indicates complex coefficients in the frequency domain of the complex filter in the transform domain, 2·L+1 denotes an order of the complex filter, and (·)* denotes a conjugate signal of the complex signal.

27. The DVB-T receiver of claim 26, wherein a bandwidth of the complex filter is a duration of a guide interval.

28. The DVB-T receiver of claim 26, wherein a starting frequency of the complex filter in the transform domain is more than 2.5 percent smaller than the duration of the guide interval.

29. The DVB-T receiver of claim 26, wherein a cut-off frequency of the complex filter in the transform domain is less than 97.5 percent of the duration of the guide interval.
